(19) United States
(12) Patent Application Publication
(10) Pub. No.: US 2006/0285470 A1
(43) Pub. Date: Dec. 21, 2006

(54) Hologram device and hologram recording/reproducing method

(75) Inventors: Kunihiko Hayashi, Kanagawa (JP); Nobuhiro Kihara, Kanagawa (JP); Muneyasu Maeda, Kanagawa (JP)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Sony Corporation, Tokyo (JP)

(21) Appl. No.: 11/447,729

(22) Filed: Jun. 6, 2006

(30) Foreign Application Priority Data
Jun. 8, 2005 (JP) 2005-168179

(51) Int. Cl. G11B 7/00

(52) U.S. Cl. 369/103

(57) ABSTRACT

In a hologram device which records information of an interference fringe of signal light and reference light onto a hologram recording medium and which reproduces the recorded information by emitting the reference light onto a recording area of the hologram recording medium, the device includes a recording/reproducing controller performing a control operation of repeatedly recording the information and reproducing the recorded information immediately after the recording of the information in an alternating fashion.

### CROSS REFERENCES TO RELATED APPLICATIONS

The present invention contains subject matter related to Japanese Patent Application JP 2005-168179 filed in the Japanese Patent Office on Jun. 8, 2005, the entire contents of which are incorporated herein by reference.

### BACKGROUND OF THE INVENTION

1. Field of the Invention

The present invention relates to a hologram recording/reproducing method for recording an interference fringe of two light beams onto a hologram recording medium and for reproducing data on the basis of light diffracted by the recorded interference fringe, and to a hologram device.

2. Description of the Related Art

In recent years, holographic technology has been developed rapidly towards practical application of a holographic memory, which is drawing much attention as a powerful candidate against optical discs of the next generation and the generation after that. Development of a holographic data storage system that performs recording and reproducing of large-volume data using the holographic technology has been proposed.

According to a hologram recording technique in related art, a recording operation is implemented by producing an interference fringe of reference light and signal light on a hologram recording medium and then recording the interference fringe on the hologram recording medium. In view of achieving practical application, a hologram recording device in related art may be problematic in that optical paths of the reference light and the signal light may change by about one-tenth of a wavelength if the device vibrates during an exposure process or the interference fringe may change if the optical paths of the reference light and the signal light vibrate, thus inhibiting a proper recording operation. In order to solve such problems, positioning control (servo) of a pickup unit having a high frequency response characteristic that can compensate for such vibration has been developed recently. However, unlike a typical optical recording technique where recording is performed one bit at a time, it is extremely difficult to implement positioning control in hologram recording while inhibiting aberration since holograms are recorded two-dimensionally. Therefore, with hologram recording, simply increasing the frequency response characteristic of a pickup unit does not necessarily solve the abovementioned problems.

Meanwhile, if an error occurs in a typical optical disc, such as DVD (digital versatile disc) and BD (blue-ray disc), the error can be corrected by a signal processing technique or an error correcting technique. However, these optical discs are limited in that if an unexpected error occurs, at least the corresponding track entirely becomes defective. A typical data storage disc generally allows recording of one track, which means that if such an error occurs, the whole disc may have to be discarded. This results in a waste of time and money for the recording medium.

Hologram recording media similarly have the same problems as the current optical discs. This means that in a case where an error occurs, which may be not correctable by a signal processing technique or an error correcting technique, the hologram recording medium with the error may have to be discarded in the same reason as described above. However, similar to existing optical discs, if the recording volume of hologram recording media is increased, it can be assumed that the cost of hologram recording media will increase accordingly. Therefore, it is highly desirable to prevent discarding of expensive media.

In hologram recording, a multiplex recording technique is applied in order to increase the recording density. One example of a multiplex recording technique is an angular multiplexing technique in which an incident angle of reference light on a hologram recording medium is changed by a mirror so as to record multiplex data onto a single book (for example, see Japanese Unexamined Patent Application Publication No. 2003-337524, p. 11, FIG. 5). In this case, the multiplex-recording process is implemented by changing the angle of the mirror at high speed to set the incident angle.

### SUMMARY OF THE INVENTION

FIGS. 4A and 4B illustrate a movement of a mirror in related art. A characteristic of an ideal movement of the mirror is shown in FIG. 4B. However, it may actually be difficult to attain this movement characteristic since the zero-returning sections are overhead. Thus, the mirror is moved to show a characteristic shown in FIG. 4A in which recording is implemented during a forward movement (period a) and a reverse movement (period b) of the mirror. However, in an angular multiplexing technique, a scheduling process for sequentially changing the intensity ratio between the signal light and the reference light is performed every time the angle is changed. Thus, the schedules have to be switched between the forward and reverse movements of the mirror, and moreover, when performing additional writing, it has to be determined whether to start with whichever one of the schedules for the forward and reverse movements. This complicates the control operation and may take too much time for the schedule selection for additional writing, thus resulting in a bad startup.

It is desirable to provide a hologram recording/reproducing method which prevents discarding of a whole medium as a result of a writing error, and which achieves smooth and fast additional writing by having only a single schedule for additional writing. In addition, it is also desirable to provide a hologram device which uses this method.

According to an embodiment of the present invention, in a hologram device which records information of an interference fringe of signal light and reference light onto a hologram recording medium and which reproduces the recorded information by emitting the reference light onto a recording area of the hologram recording medium, the device includes a recording/reproducing controller performing a control operation of repeatedly recording the information and reproducing the recorded information immediately after the recording of the information in an alternating fashion.

According to another embodiment of the present invention, in a hologram recording/reproducing method for recording information of an interference fringe of signal light and reference light onto a hologram recording medium and for reproducing the recorded information by emitting the reference light onto a recording area of the hologram recording medium, the method includes the step of performing a control operation of repeatedly recording the information and reproducing the recorded information immediately after the recording of the information in an alternating fashion.

Furthermore, the hologram recording and reproducing processes may be implemented on the basis of an angular multiplexing technique. In this case, the control operation for alternately switching between the multiplex recording process of the information onto a book and the reproducing process of the multiplexed information from the book may be performed in accordance with a period in which an incident angle of the reference light on the hologram recording medium is increased and a period in which the incident angle is decreased.

Furthermore, the method may further include the steps of detecting an error by comparing the reproduced information with the recorded information corresponding to the reproduced information, and recording the corresponding recorded information onto a new book if an error is detected.

Accordingly, in a hologram recording/reproducing operation based on an angular multiplexing technique, multiplex recording of information on a book may be performed, for example, in a period in which an angle of a mirror for changing an incident angle between a normal vector of a hologram recording medium and an incidence vector of reference light is increased, whereas a reproducing operation for reading out the information from the book may be performed in a period in which the angle is decreased. The multiplex recording operation and the reproducing operation are performed in an alternating fashion. In addition, an error inspection of the reproduction information may be implemented, and if an error is inspected, the corresponding original recorded information may be recorded onto a new book. Consequently, this prevents the whole medium from being discarded as a result of a writing error. Furthermore, since the recording may be performed in a period in which the angle of the mirror, for example, is increased, only a single schedule for changing the intensity ratio between the signal light and the reference light by means of the incident angle of the reference light may be necessary. Thus, when performing additional writing, a recording operation can be implemented simply in accordance with this schedule, thereby achieving a smooth and fast additional writing operation.

### BRIEF DESCRIPTION OF THE DRAWINGS

FIG. 1 is a block diagram of a hologram device according to a first embodiment of the present invention;

FIG. 2 is a graph showing an incident angle between a normal vector of a hologram recording medium and an incidence vector of reference light shown in FIG. 1;

FIG. 3 is a flow chart of a control operation performed by a system controller shown in FIG. 1; and

FIGS. 4A and 4B are graphs each showing a movement of an angle-adjustable mirror used in a hologram recording/reproducing operation in related art.

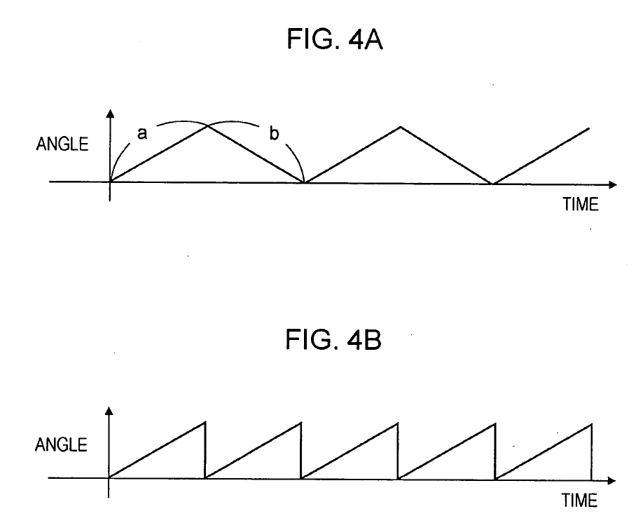

### DESCRIPTION OF THE PREFERRED EMBODIMENTS

In a hologram recording/reproducing method applying an angular multiplexing technique, multiplex recording of information on a book is performed, for example, in a period in which an angle of a mirror for changing an incident angle between a normal vector of a hologram recording medium and an incidence vector of reference light is increased, whereas a reproducing operation for reading out the information from the book is performed in a period in which the angle is decreased. The multiplex recording operation and the reproducing operation are performed in an alternating fashion. In addition, an error inspection of the reproduction information is implemented, and if an error is inspected, the corresponding original recorded information is recorded onto a new book. Accordingly, this prevents the whole medium from being discarded as a result of a writing error and achieves smooth and fast additional writing due to having only a single schedule for additional writing.

### First Embodiment

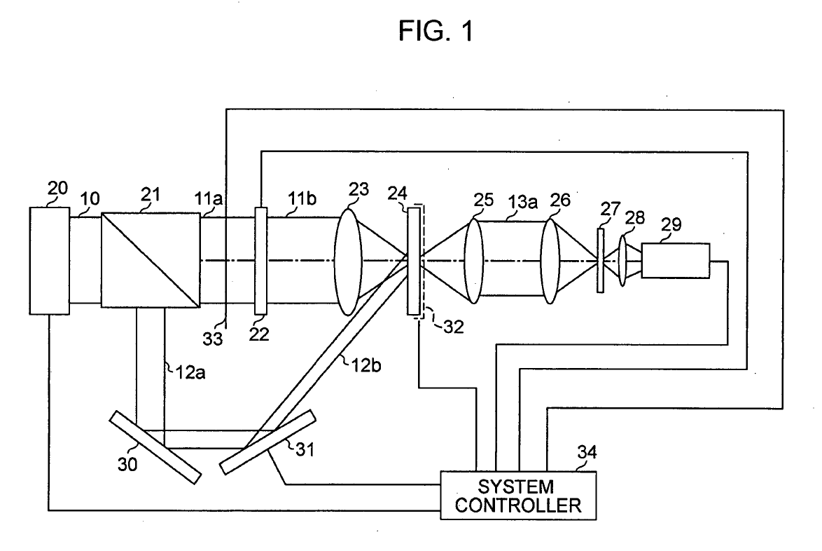

FIG. 1 is a block diagram of a hologram device according to a first embodiment of the present invention. The hologram device includes a laser light source 20, a polarizing beam splitter (PBS) 21, a spatial modulator 22, a signal-light lens 23, a hologram recording medium 24, reproduction-light lenses 25 and 26, a diaphragm 27, a lens 28, an image-capturing unit 29, a path-changing mirror 30, an angle-adjustable mirror 31, a stage 32 for moving the hologram recording medium 24, a shutter 33 that transmits or intercepts signal light, and a system controller 34 that controls the operation of the device.

The operation of the hologram device according to the first embodiment will be described below. When performing a recording operation, the system controller 34 opens the shutter 33. The laser light source 20 emits a laser beam 10, which is split into a P-wave 11a and an S-wave 12a by the PBS 21. The laser light source 20 is generally a type that generates light on a wavelength near the visible light range. The P-wave 11a passes through the shutter 33 and enters the spatial modulator 22 where the P-wave 11a is subject to spatial modulation in accordance with a data page displayed on the spatial modulator 22 so as to become signal light 11b. The spatial modulator 22 is generally defined by a transmissive liquid crystal display panel or a reflective liquid crystal display panel, or may be defined by a unit used in an image formation device, such as a digital micromirror device (DMD) and a grating light valve (GLV). The signal light 11b is focused onto a recording area (book) of the hologram recording medium 24 by the signal-light lens 23. The hologram recording medium 24 does not necessarily have to be perpendicular to the optical axis of the signal light 11b.

On the other hand, with regard to the S-wave 12a, the path thereof is changed by the path-changing mirror 30. Subsequently, the S-wave 12a enters the angle-adjustable mirror 31 as reference light 12b. The angle of the angle-adjustable mirror 31 is adjustably controlled by the system controller 34, such that the angle-adjustable mirror 31 sets an incident angle of the reference light 12b on the hologram recording medium 24. The reference light 12b with the set incident angle is emitted towards the hologram recording medium 24 in a manner such that the reference light 12b covers the incident area of the signal light 11b on the hologram recording medium 24. The signal light 11b and the reference light 12b interfere with each other in the recording area (book) of the hologram recording medium 24, and the interference information is recorded onto the recording area. Subsequently, the spatial modulator 22 displays a subsequent data page to be recorded, and the angle-adjustable mirror 31 changes the incident angle of the reference light 12b. In the same manner as described above, the information related to the subsequent data page to be recorded is multiplexed as interference information onto the same recording area (book).

When performing a reproducing operation, the system controller 34 closes the shutter 33. The recording area (book) of the hologram recording medium 24 is irradiated solely with the same reference light 12b, as reproduction reference light 12b, used for recording. This generates diffracted light corresponding to the interference information recorded on the hologram recording medium 24. The diffracted light passes through the reproduction-light lenses 25 and 26 constituting a 4f system so as to become reproduction light 13a. The reproduction light 13a is then converged by the diaphragm 27. A section where the diffracted light is generated and a converging section of the diaphragm 27 have a mirror-image relationship. The diaphragm 27 removes light other than 0-th order light and light produced as a result of crosstalk from adjacent recording areas, and transmits only the light carrying the reproduction information. The transmitted light is focused onto the image-capturing unit 29 by the lens 28, and is subject to photoelectric conversion by the image-capturing unit 29 so as to become reproduction data.

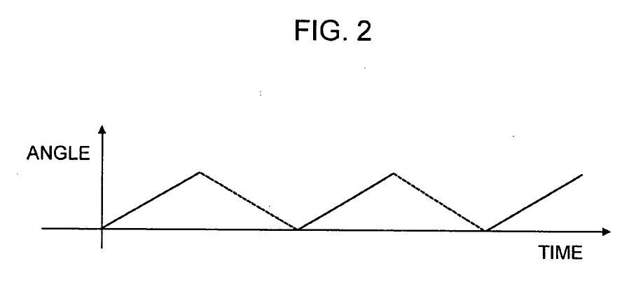

In the first embodiment, the system controller 34 adjusts the angle of the angle-adjustable mirror 31 so as to alternately switch between the recording and reproducing operations. In a case where an incident angle between a normal vector of the hologram recording medium 24 and an incidence vector of the reference light 12b, which is changeable in response to an angle adjustment of the angle-adjustable mirror 31, has a characteristic as shown in FIG. 2, a recording operation is performed in a period indicated by a solid line (i.e. an increasing period of the incident angle) and the reproducing operation is performed in a period indicated by a dashed line (i.e. a decreasing period of the incident angle). The system controller 34 controls the recording operation and the reproducing operation in an alternating fashion. In other words, the system controller 34 opens the shutter 33 for a solid-line period, and in this state, the system controller 34 switches the data pattern displayed on the spatial modulator 22 to another one and controls the angle adjustment operation of the angle-adjustable mirror 31 so as to perform a multiplex-recording operation on a single book in the hologram recording medium 24. Subsequently, in a dashed-line period, the system controller 34 closes the shutter 33 and controls the angle adjustment operation of the angle-adjustable mirror 31 so as to change the incident angle of the reference light 12b on the hologram recording medium 24, thereby reading out the multiplexed data from the immediately previously recorded book. Subsequently, the system controller 34 repeats the control operation described above. Here, a minimum incident angle is set as the basis for the incident angle mentioned above.

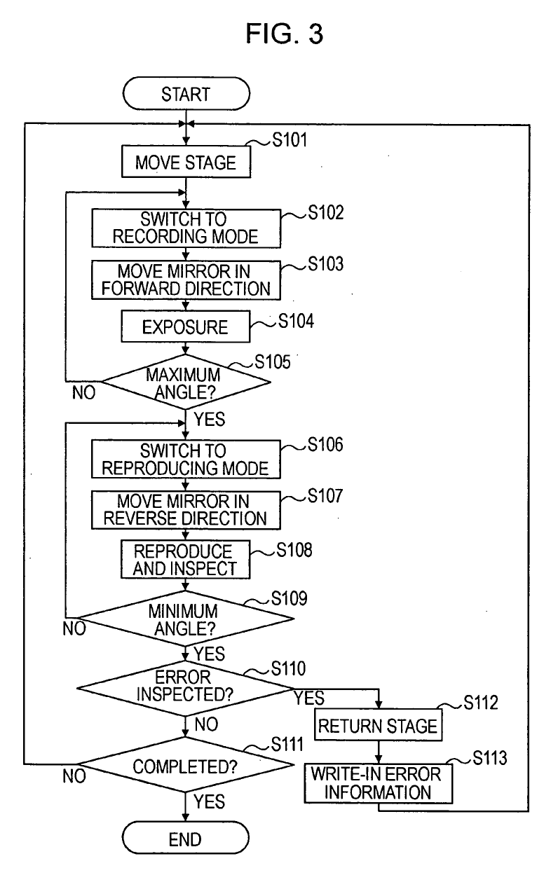

FIG. 3 is a flow chart of the control operation performed by the system controller 34. In step S101, the system controller 34 controls the stage 32 in order to move the hologram recording medium 24. In step S102, the system controller 34 switches the hologram device to a recording mode so that a hologram recording operation is implemented on a predetermined recording area (book). In step S103, the system controller 34 adjusts the angle of the angle-adjustable mirror 31 in a solid-line period shown in FIG. 2, and switches the data pattern displayed on the spatial modulator 22 to another one. In step S104, the system controller 34 adjusts an intensity ratio between signal light 100 and reference light 200 in accordance with a schedule and performs an exposure process so as to record data. In step S105, it is determined whether an incident angle between a normal vector of the hologram recording medium 24 and an incidence vector of the reference light 200 has reached a maximum angle in response to an angle adjustment of the angle-adjustable mirror 31. If the incident angle has reached its maximum, the operation proceeds to step S106. If not, the operation returns to step S102. By repeating the cycle from step S102 to step S104, multiplex-recording on a single book is achieved.

In step S106, the hologram device is switched to a reproducing mode, and the shutter 33 is thus closed. In step S107, the angle of the angle-adjustable mirror 31 is adjusted in a dashed-line period shown in FIG. 2. In step S108, the immediately previously recorded book is irradiated solely with the reference light 200 so as to reproduce data therefrom, and an inspection process is performed to determine whether or not there is an error in the data. In step S109, the reproducing process is repeated until the incident angle between the normal vector of the hologram recording medium 24 and the incidence vector of the reference light 200 reaches a minimum angle in response to an angle adjustment of the angle-adjustable mirror 31, and the error inspection is implemented by reading out the multiplexed data entirely from the book. In step S110, based on the error inspection process, it is determined whether or not the reproduction data has an error. The reproduction data is compared with preliminarily recorded data, and if it is determined that the reproduction data has no error, the operation proceeds to step S111 where it is determined whether or not the data recording on the hologram recording medium 24 is completed. If it is determined in step S111 that the data recording is completed, the recording/reproducing operation is completed, whereas if it is determined in step S111 that the data recording is not completed, the operation returns to step S101. On the other hand, if it is determined in step S110 that the reproduction data has an error, the operation proceeds to step S112 where the stage 32 is controlled so as to return to the recording position of the hologram recording medium 24. Subsequently, in step S113, the error information is written into the recording position. The operation then returns to step S101 so as to start a process for writing the data determined to be an error onto a new book in the same manner as described above.

According to the first embodiment, when a hologram recording operation is to be performed using an angular multiplexing technique, data recording is performed when the angle-adjustable mirror 31 that changes an incident angle of reference light on a hologram recording medium is rotated in a forward direction (solid line in FIG. 2). On the other hand, when the angle-adjustable mirror 31 is rotated in a reverse direction (dashed line in FIG. 2), immediately previously recorded book data is read out and inspected for an error. When there is an error, the data is immediately recorded onto a new book. Therefore, even if the recorded data is determined to be an error, it is only necessary to mend one book. This implies that if a recording operation were to be performed in an environment where a writing error may likely to occur due to, for example, vibration, the whole recording medium is prevented from being discarded as a result of a writing error. Moreover, since a recording operation is performed in a period in which the incident angle between the normal vector of the hologram recording medium and the incidence vector of the reference light is increased in response to an angle adjustment of the angle-adjustable mirror 31, only a single schedule may be necessary for the additional writing process, meaning that a schedule selection process can be omitted. Accordingly, a smooth and fast additional writing operation can be achieved.

The technical scope of the present invention is not limited to the above embodiments, and modifications are permissible within the scope and spirit of the present invention. For example, in the first embodiment, although a recording operation is performed in the solid-line period and a reproducing operation is performed in the dashed-line period in FIG. 2, the two operations may alternatively be inverted between the two periods. In other words, the same advantage as in the first embodiment can be achieved by performing a reproducing operation in the solid-line period and performing a recording operation in the dashed-line period.

It should be understood by those skilled in the art that various modifications, combinations, sub-combinations and alterations may occur depending on design requirements and other factors insofar as they are within the scope of the appended claims or the equivalents thereof.

What is claimed is:

1. A hologram device which records information of an interference fringe of signal light and reference light onto a hologram recording medium and which reproduces the recorded information by emitting the reference light onto a recording area of the hologram recording medium, the device comprising:
recording/reproducing controlling means performing a control operation of repeatedly recording the information and reproducing the recorded information immediately after the recording of the information in an alternating fashion.

2. The hologram device according to claim 1, further comprising multiplex recording/reproducing means configured to perform multiplex-recording of information on a single book and reproduce the multiplexed information from the book by changing an incident angle between a normal vector of the hologram recording medium and an incidence vector of the reference light, the incident angle being changed by adjusting an angle of a mirror that changes a path of the reference light,
wherein the recording/reproducing controlling means allows the information to be multiplexed onto the book in a period in which the incident angle is increased in response to the angle adjustment of the mirror, and allows the multiplexed information to be reproduced from the book, having the information immediately previously recorded thereon, in a period in which the incident angle is decreased in response to the angle adjustment of the mirror.

3. The hologram device according to claim 1, further comprising multiplex recording/reproducing means configured to perform multiplex-recording of information on a single book and reproduce the multiplexed information from the book by changing an incident angle between a normal vector of the hologram recording medium and an incidence vector of the reference light, the incident angle being changed by adjusting an angle of a mirror that changes a path of the reference light,
wherein the recording/reproducing controlling means allows the information to be multiplexed onto the book in a period in which the incident angle is decreased in response to the angle adjustment of the mirror, and allows the multiplexed information to be reproduced from the book, having the information immediately previously recorded thereon, in a period in which the incident angle is increased in response to the angle adjustment of the mirror.

4. The hologram device according to any one of claims 1 to 3, further comprising error detecting means detecting an error by comparing the information reproduced by the recording/reproducing controlling means with the recorded information corresponding to the reproduced information.

5. The hologram device according to claim 4, wherein if an error is detected, the recording/reproducing controlling means subsequently records the corresponding recorded information onto a new book.

6. The hologram device according to claim 4, wherein if an error is detected, the recording/reproducing controlling means records the error information onto a predetermined recording area.

7. A hologram recording/reproducing method for recording information of an interference fringe of signal light and reference light onto a hologram recording medium and for reproducing the recorded information by emitting the reference light onto a recording area of the hologram recording medium, the method comprising the step of:
performing a control operation of repeatedly recording the information and reproducing the recorded information immediately after the recording of the information in an alternating fashion.

8. The hologram recording/reproducing method according to claim 7, wherein the hologram recording and reproducing processes are implemented on the basis of an angular multiplexing technique, and wherein a control operation for alternately switching between a multiplex recording process of the information onto a book and a reproducing process of the multiplexed information from the book are performed in accordance with a period in which an incident angle of the reference light on the hologram recording medium is increased and a period in which the incident angle is decreased.

9. The hologram recording/reproducing method according to one of claims 7 and 8, further comprising the steps of:
detecting an error by comparing the reproduced information with the recorded information corresponding to the reproduced information; and
recording the corresponding recorded information onto a new book if an error is detected.

10. A hologram device which records information of an interference fringe of signal light and reference light onto a hologram recording medium and which reproduces the recorded information by emitting the reference light onto a recording area of the hologram recording medium, the device comprising:
a recording/reproducing controller performing a control operation of repeatedly recording the information and reproducing the recorded information immediately after the recording of the information in an alternating fashion.
